(19) United States
(12) Patent Application Publication
(10) Pub. No.: US 2002/0083329 A1
(43) Pub. Date: Jun. 27, 2002

(54) Fingerprint reading security system in an electronic device

(76) Inventor: Shoichi Kiyomoto, Tokyo (JP)

Correspondence Address: JEFFREY C. LEW, 2205 SILVERSIDE ROAD, WILMINGTON, DE, 19810, US

(21) Appl. No.: 10/029,613

(22) Filed: Dec. 21, 2001

(30) Foreign Application Priority Data
Dec. 25, 2000 (JP) 2000-393736

(51) Int. Cl. H04L 9/00

(52) U.S. Cl. 713/186

(57) ABSTRACT

This invention discloses an inexpensive, lightweight, and miniature-size fingerprint reading unit for an electronic apparatus such as a mobile computer terminal and a portable telephone system. It includes a fingerprint authentication method for the apparatus. The optical system of the fingerprint reading unit includes an auxiliary lens between the fingerprint stamping area and a digital camera positioned to capture an image of a fingerprint placed on the stamping area.

### FIELD OF THE INVENTION

This invention relates to a method and system for protecting an electronics apparatus for use only by an authorized operator. More specifically, the invention pertains to a small optical sensing system integral to a keyboard of the apparatus adapted to capture a fingerprint of a potential user to verify that such person is approved to user the apparatus.

### BACKGROUND AND SUMMARY OF THE INVENTION

The use of mobile electronics devices such as portable computers and cellular or digital wireless telephones is rapidly growing. Such mobile electronics devices are very susceptible to being misplaced or stolen. Data stored in an electronics device could be accessed by unauthorized persons if the device becomes lost or stolen.

To prevent problems arising from misuse or theft of important information, security systems have been developed to assure that only authorized persons are permitted to operate an electronics device. Such systems include an operator authentication function with an integrated fingerprint-reading unit. This enables the identity of the operator to be determined by fingerprint identification to bar further access to the device to all but authorized persons.

There are several types of fingerprint reading units for operator identity authentication. These types include optical devices, and semiconductor sensors operative to measure electrostatic capacitance, body temperature or finger pressure. For example, Japanese Patent Application No. 10-326338 (1998) disclosed a fingerprint-reading unit with an optical device as shown FIG. 5.

The electronics marketing industry is very sensitive to the size, weight and cost of mobile communications and data computing equipment. More users are attracted to smaller, lighter and lower cost devices. Security systems for wireless computers and portable telephones add to the weight and cost. Therefore, it is desirable to develop an inexpensive and lightweight fingerprint authentication unit so that users of mobile computer terminals and/or portable telephones equipped with authentication features find the devices easy to carry and affordable.

Prior art fingerprint reading and other types of security units are far from providing small size, light weight and low cost. Applicant is unaware of any available device that may be built into a hand held portable electronics apparatus for fingerprint authentication.

For example, the size of the optical fingerprint scanner as shown in FIG. 5, also invented by the Applicant for the present invention, is too large to integrate with an electronics apparatus. The light sensor device or “imager” and associated parts used in that fingerprint reading unit cost $20 to $40, which is an additional cost of the product. Semiconductor device elements for sensing fingerprints also have a similar cost range. These costs are too high for a portable phone system.

One approach to solving the problem of making a fingerprint reading and authentication unit small, light weight and inexpensive would seem to utilize functions already available on an electronics apparatus. For example, a portable computer electronics apparatus 2 having a built in digital camera unit 1, shown in FIG. 1, recently became commercially available. It would be helpful to provide a lighter and less expensive fingerprint reading system to use the built in digital camera unit that is already part of the electronics apparatus because less new elements would be needed to add to obtain the fingerprint reading/authentication functions. Unfortunately, as will be explained, existing digital camera units such as exemplified by that in FIG. 1 cannot adequately read and authenticate fingerprints as desired for electronics apparatus security system purposes.

### SUMMARY OF THE INVENTION

Accordingly, this invention provides an electronic apparatus comprising

a digital camera;

a fingerprint reading unit having a stamping area; and

an optical system positioned in the fingerprint reading unit and comprising a lens additional to any lens incorporated in the digital camera,

in which the fingerprint reading unit is operative to direct an image of an object on the stamping area through the lens system for capture by the digital camera.

There is also provided a fingerprint reading and authentication method comprising the steps of

providing an electronic apparatus comprising a digital camera, and a fingerprint reading unit having a stamping area,

capturing into the digital camera a fingerprint image of a finger in contact with the stamping area,

extracting information from the fingerprint image which uniquely characterizes the fingerprint image,

comparing the information extracted which the fingerprint image to pre-registered fingerprint image data,

authenticating whether the fingerprint image is the same as any image contained in the pre-registered fingerprint image data.

### BRIEF DESCRIPTION OF THE DRAWINGS

FIG. 1 shows a perspective view of an electronic apparatus with built-in digital camera mechanism.

FIG. 2 is a diagram showing elements of a fingerprint reading unit attached to the digital camera mechanism of FIG. 1 as used to read a fingerprint.

FIG. 3a shows an embodiment of a fingerprint reading unit with a prism and an electrical auxiliary light source.

FIG. 3b shows an embodiment of a fingerprint reading unit with a prism, a window adapted to admit outside light to the prism, and a shield plate to block direct light that did not pass the prism.

FIG. 4 illustrates an embodiment of a fingerprint reading unit with a pinhole plate.

FIG. 5 shows an optical fingerprint reading apparatus of prior art.

FIG. 6 diagramatically shows the principle mechanism of an optical system of a digital camera to be mounted on an electronic apparatus according to embodiments of this invention.

FIG. 7 diagramatially illustrates the placement of an additional optical lens to correct hyperopia according to embodiments of this invention.

FIG. 8a shows an image pattern to be captured with a fingerprint reading unit according to this invention of the type shown in FIG. 3a or 3b.

FIG. 8b shows the image pattern of FIG. 8a as captured with a fingerprint reading unit according to this invention.

FIG. 9 is a flow diagram for process steps from capturing a fingerprint image to authenticating a fingerprint according to an embodiment of this invention.

FIG. 10 is a flow diagram for process steps from capturing a fingerprint image to authenticating a fingerprint according to another embodiment of this invention.

### DETAILED DESCRIPTION

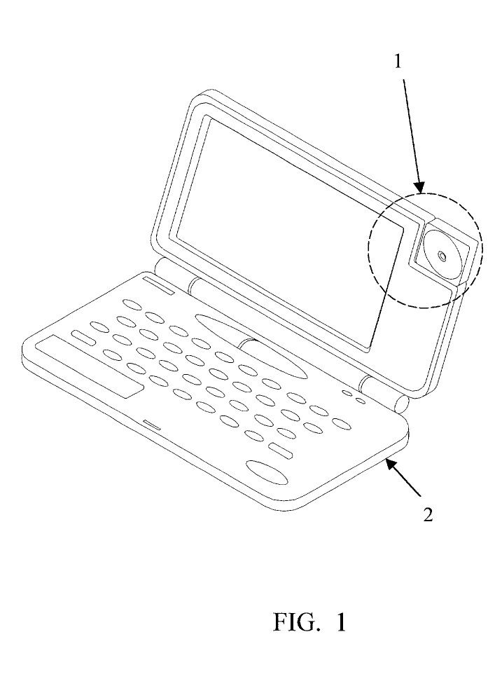

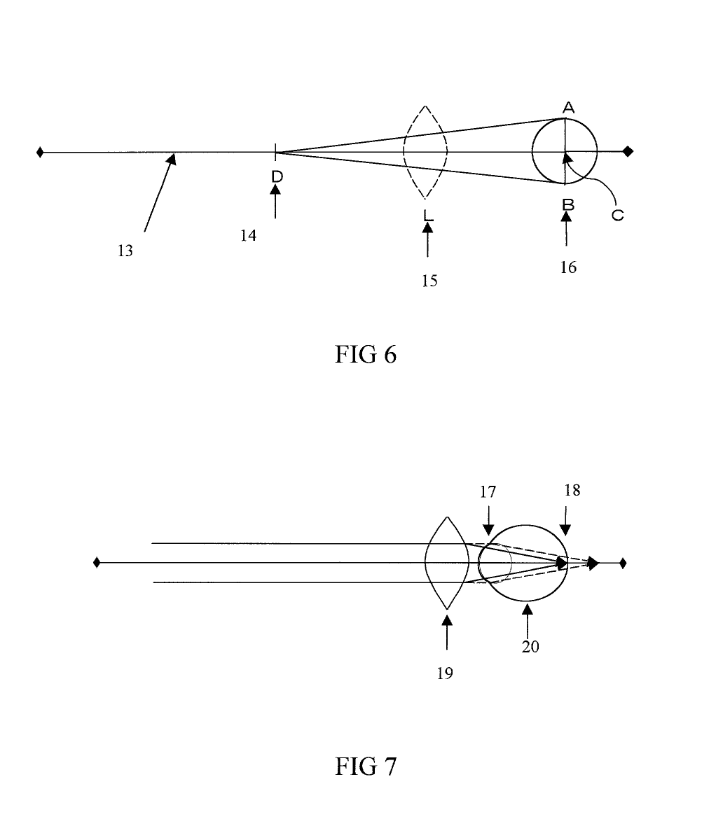

Referring to FIG. 6, it is seen that a digital camera of the type shown in FIG. 1 has an imager 16 and a camera lens, L, system 15. In the same figure, point C and line segment AB represent the center and the physical size of the imager, respectively. The size of line segment AB is on the order of millimeter scale. Point D shows the focal point 14 of the camera lens system 15, and angle ADB is called the image angle or the sight angle of the camera lens system. When the sight angle of a camera lens is more than 60 degrees, it is called wide angle. A digital camera in an electronics apparatus typically is designed to capture from a wide angle image to a telescopic image with a miniature lens system whose focal length is approximately 100 mm or shorter, and often fixed.

In order to capture fingerprint image with adequately high resolution (about 20 lines per 1 mm) and high contrast (256 tones or more), the focal length must be shorter than that of the aforementioned camera lens. In principle, this invention accomplishes this objective by adding a corrective lens. The corrective lens functions much like an appropriate pair of eye glasses corrects vision of a person with hyperopia so that an object closer to the person may be observed clearly.

FIG. 7 illustrates this corrective lens for hyperopia. An eye lens 17 of a person with hyperopia is unable to focus parallel light from infinite distance to a particular point on retina 18 as indicated by broken lines. However, an additional corrective lens 19 will focus the light to the point on retina 18. The solid lines inside an eyeball 20 represents the corrected optical path.

Considering the above optical correction procedure, this invention provides a fingerprint-reading unit which has a corrective lens system in front of the digital camera and a mechanism of an electronic apparatus to form a coaxial optical system. This invention also provides methods of fingerprint capture and authentication utilizing the fingerprint-reading unit built-in an electronic apparatus.

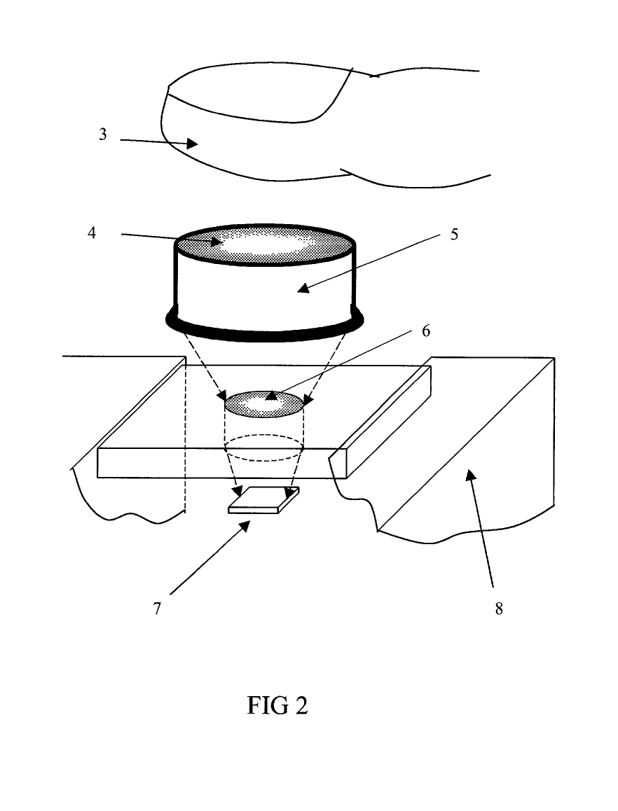

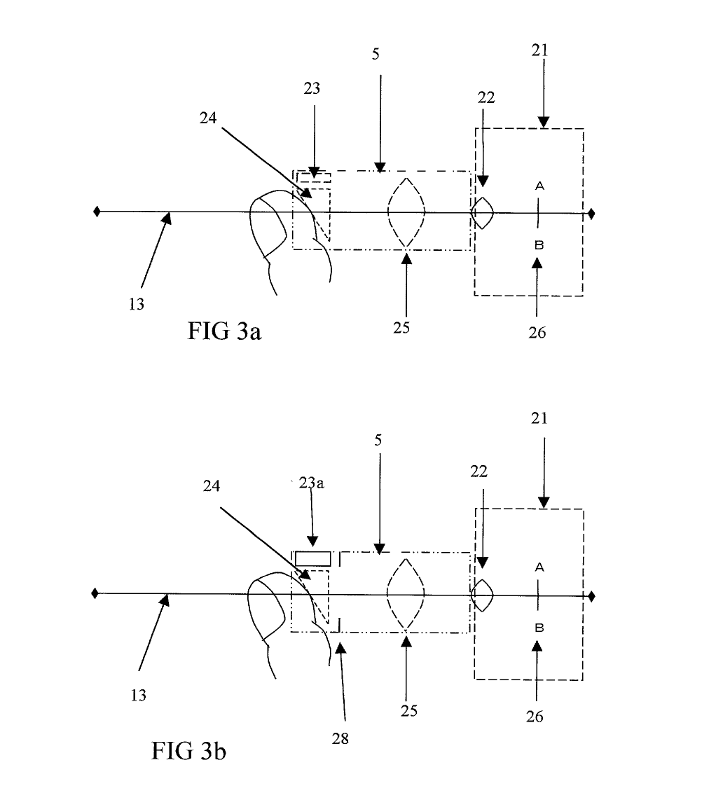

Referring to FIG. 2, an electronic apparatus 8 such as a mobile computer terminal or a portable telephone system contains a digital camera mechanism 21 (FIGS. 3a, 3b) which has light condensing unit 6 and light detection unit 7. The present invention places fingerprint reading unit 5, which has internal auxiliary lens system 25 for correcting hyperopia so that the auxiliary lens 25 forms a coaxially aligned optical system with the digital camera mechanism 21.

According to the present invention, by putting finger 3 onto stamping area 4 of fingerprint-reading unit 5, the fingerprint can be read with an accuracy and resolution suitable for fingerprint authentication using the digital camera mechanism 21.

The memory unit of the electronics apparatus stores the captured fingerprint image, which may be used for fingerprint authentication, or for sending the captured fingerprint image and/or extracted data from minutiae (that is, data representing positions of characteristic reference points derived from the captured fingerprint image) to a data center by utilizing a communication function of the electronic apparatus so that the data center may perform authentication.

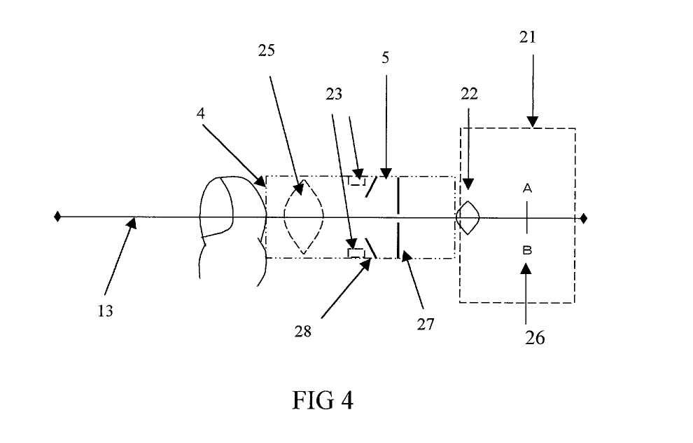

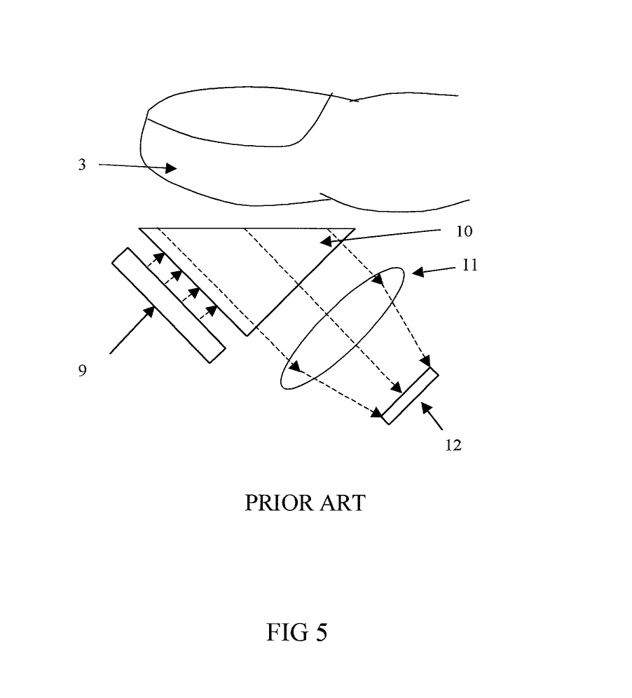

Therefore, this invention may verify a person who has right to use the electronic apparatus and its accessible data and also a person who has right to utilize a commercial service including a communication service via a mobile terminal and/or a portable telephone, and information providing service. Furthermore, this invention is useful in improving security in charging a service fee to a user, and other on-line procedures. A preferred embodiment of this invention is now described, with reference to FIGS. 3a, 3b and 4. In order to achieve adequate contrast and resolution of a fingerprint image within a limited space, a fingerprint reading unit may use an internal prism, or a pinhole plate based upon the principle of a pinhole camera.

FIGS. 3a and 3b show examples using fingerprint reading unit 5 with an internal prism 24. The fingerprint reading unit has aforementioned auxiliary lens system 25 for correction of hyperopia, prism 24 and auxiliary light source 23 to enhance the image contrast whereas camera lens system 22 in front of imager plane 26 is attached inside digital camera mechanism 21. The fingerprint reading unit 5 is placed in front of the digital camera mechanism 21 so that they form a coaxially aligned optical system.

Auxiliary lens system 25 may be non-spherical lenses to reduce aberration effect. This may be accomplished particularly by using a plastic lens with variable index of refraction. The position of the cylindrical enclosure of the optical system of fingerprint-reading system 5 may be adjustable with gear thread mechanism so that the focus may be accurately adjusted.

Electrical power to auxiliary light source 23 shown in FIG. 3a may be supplied with a battery installed inside fingerprint reading unit 5. The power source may be synchronized with the electronics apparatus for reducing power consumption. Furthermore, a light emitting polymer with electrodes may be attached to the fingerprint stamping area for emitting light when a finger makes a contact with the fingerprint stamping area.

Another mechanism for reducing power consumption by fingerprint-reading unit 5 is to introduce outside light, including sun light, into prism 24 through light window 23a which is made of transparent material such as acryl, provided fingerprint-reading unit 5 is properly shielded from outside light. As shown in FIG. 3b, only transmitted light may be introduced into auxiliary lens system 25 through light shield plate 28 which is attached behind prism 24.

FIG. 4 illustrates an embodiment of this invention using the optical principle of a pinhole camera in order to enhance the resolution of fingerprint image. In this embodiment, there is light shield plate 28 attached in front of pinhole plate 27 so that light from several auxiliary light sources 23 may be blocked from directly reaching pinhole plate 27. Thus, auxiliary lens system 25 receives reflection light from a fingerprint, achieving substantial enhancement of resolution.

To improve contrast of the fingerprint image, the film stamping area material 4 should be of a semi-transparent thin film such as paper including traditional Japanese paper, crystallized polymer including polyethylene, polypropylene, and polyethylene terephthalate, and amorphous polymer film including polyvinylchloride, polyester, and polycarbonate. For improving adhesion of a dried finger with fingerprint stamping area 4 of prism 24, adhesive film made of elastomer including silicone and urethane rubbers may be used.

Nevertheless, an acquired fingerprint image with the embodiment of the pinhole camera will be inevitably distorted near its circumference, especially compared with those images captured with the prism-imager optical systems shown in FIGS. 3a, or 3b.

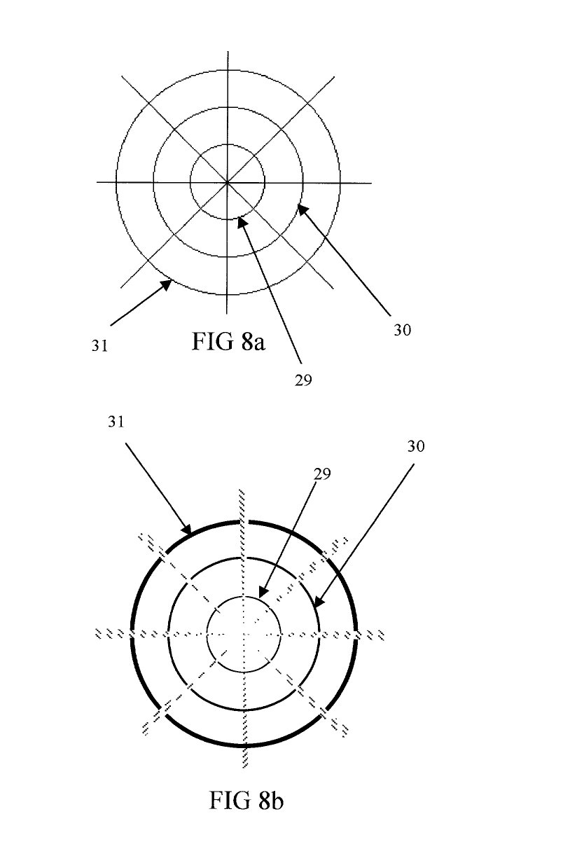

Designing fingerprint-reading unit affects the degradation of the image: it affects the contrast, the resolution, or the distortion of a captured image. FIGS. 8a and 8b help explain this circumferentially increasing distortion.

FIG. 8a is an ideally captured image pattern, that is, it reproduces a two dimensional pattern exactly as the original appears when viewed directly. FIG. 8b is an image pattern captured with a fingerprint reading unit according to this invention. The image of FIG. 8b may be degraded in both contrast and resolution. Furthermore, the degradation is more noticeable in outer areas rather than inner areas. Note that compared to FIG. 8a, the radially outward extending lines and the circles 29, 30 and 31 appear in FIG. 8b wider and less distinct as the distance from the center increases.

The above mentioned degradation presents common technical issues on “placing finger” and “physical condition of finger (e.g., weariness and disease of finger),” which should be considered at the time of extraction of minutiae from a fingerprint. Japanese Patent Applications No. 10-356681 (1998) and No. 11-53728 (1999) disclosed the solutions of these technical challenges. As they pointed out, these problems should be considered and take some measure in advance if such troubles routinely occur.

The above problems may be avoided by generating a signal from the electronic apparatus to instruct a proper fingerprint stamping. In addition, appropriate mark or structure may produce additional effect to instruct a proper attachment of a fingerprint-reading unit to the electronic apparatus.

In addition, software for image processing may solve the technical issues in the following manner.

For an ideally acquired, undistorted image pattern, G(x, y), shown as FIG. 8a, the degraded image, G′(x, y), shown as FIG. 8b, may be described by a two dimensional data characteristic function, F(x, y). The theory of Fourier transforms indicates that the characteristic function F(x, y) may be calculated uniquely for a given condition of the pinhole or aperture at the stage of designing a fingerprint reading unit related with this invention.

It is known that a degraded or distorted image G′(x, y) may be expressed in terms of “convolution” of the Fourier transform of the degraded characteristic function F(x, y) and an undistorted fingerprint image G(x, y) as follows:

G′(x, y)=F(x, y)*G(x, y) (1)

where asterisks (*) indicates the convolution of the Fourier transform.

Thus, when the form of the function F(x,y) is known, the undistorted image G(x, y) may be obtained from an actually captured image G′(x, y) by the following equation:

G(x, y)=F⁻¹[F(G′(x, y))/F(F(x, y))] (2)

Where F and F⁻¹ are the Fourier transform and its inverse transform, respectively.

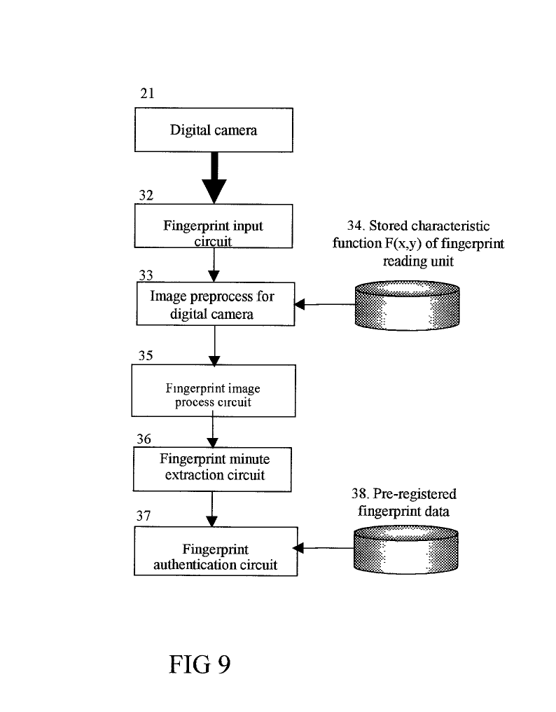

Referring to FIG. 9, a the steps in the process of fingerprint capture and authentication is as follows: the image characteristic function F(x, y) is obtained from the fingerprint reading unit and/or the electronics apparatus and is stored (process 34); the fingerprint image G′(x, y) is captured by a digital camera 21 and is input through the fingerprint reading unit 32. Then an undistorted fingerprint image G(x, y) may be obtained by the process (image preprocess 33) based upon Equation (2). With the thus obtained image G(x, y), it is possible to proceed to the fingerprint authentication process after the processing in fingerprint process circuit 35.

In order to perform the aforementioned calculation more accurately, a process of removing excessively degenerated image for fingerprint authentication at outer circumference from the “effective angle” of image, which is defined as the image area satisfying the aforementioned resolution and contrast, may be performed as a preprocess of step 33 for image captured by a digital camera.

For example, process 34 can store data describing the captured fingerprint image at the outermost circle 31 shown in FIG. 8b in a memory unit beforehand as attribute information of the fingerprint-reading unit, which will be used to mask a captured image. With an obtained fingerprint image through such preprocess prior to process 33, it is possible to perform fingerprint authentication processes starting from process 35.

Fingerprint image process circuit 35 processes the calculated fingerprint image, and minutiae extraction circuit 36 extracts minutiae of the captured fingerprint. Then, fingerprint authentication circuit 37 compares the extracted fingerprint minutiae with pre-registered fingerprint data 38 corresponding to minutiae from fingerprints of known users for authentication.

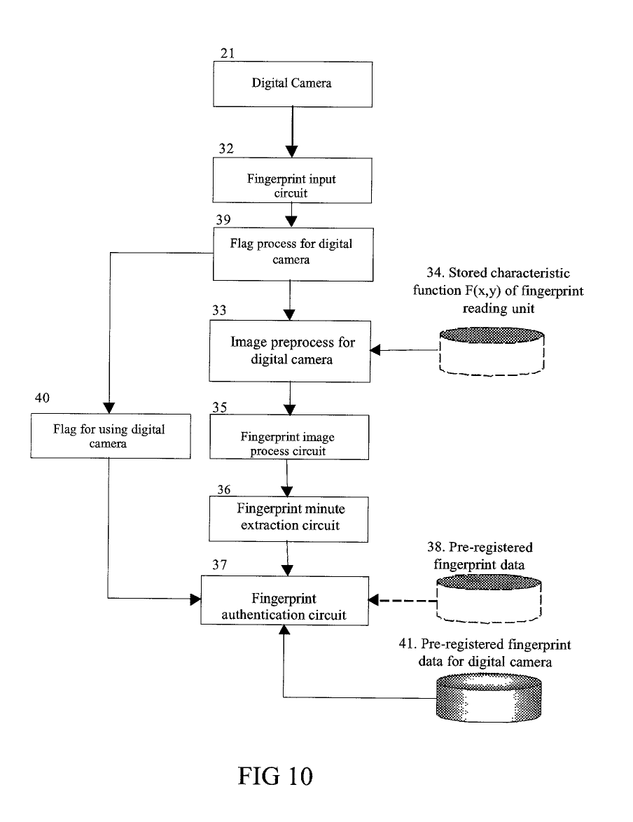

A special preprocess other than the aforementioned preprocess may be taken prior to authentication when a digital camera captures a fingerprint as shown in FIG. 10 while pre-registered fingerprint data were captured with a standard fingerprint-reading apparatus. Pre-registered fingerprint data for digital camera 41 are independently prepared in addition to the pre-registered fingerprint data 38 which were generated from minutia of fingerprint images captured with a standard fingerprint-reading apparatus of prior art. When a fingerprint-reading unit related of this invention is used, the step 39 notifies the presence of a fingerprint-reading unit of this invention to the authentication circuit 37 through the process 40 in advance so that the authentication circuit 37 may use the pre-registered fingerprint data for digital camera 41.

FIG. 9 shows a flow diagram for an authentication process utilizing minutiae or reference points of an identifying feature of the user such as a fingerprint. This process is sometimes called a “template method”. To extract the reference point information from an image captured with a digital camera, it is recommended to correct degradation or distortion of the image with the above mentioned Fourier transform algorithm.

As seen in FIG. 9, one may account for distortion of any particular digital camera unit by initially determining the characteristic function F(x,y). This is done by viewing a precisely known image characterized in digital form by data G(x,y) with the camera to generate a captured image with distortion characterized by data G′(x,y). From this information the characteristic function of the specific digital camera unit F(x,y) can be calculated using known Fourier transform analysis. This characteristic function is stored in element 34.

In step 21 an object capable of identifying the user, for example, a finger, is placed on the stamping area 4 of the electronics apparatus containing a digital camera. The image of the fingerprint is captured in step 32. In step 33 the function F(x,y) that describes the distortion characteristic of the digital camera is retrieved from storage and in step 35 equation (2) is implemented to provide a “cleaned” (i.e., less distorted) set of data that more precisely describes the fingerprint. In step 36 positions of reference points are obtained from the cleaned captured fingerprint image to produce data that is uniquely characteristic of the captured fingerprint. In step 37 the set of data taken from the fingerprint is compared to similarly formatted sets of data from pre-registered fingerprints. For example, persons who have proper authority to access the electronics apparatus will previously have registered with the administrator of the apparatus and provided fingerprint data. The minutiae data of these pre-registered fingerprints are stored in element 38. Thus the process calls for providing access to the stored pre-registration data and evaluating whether the newly acquired fingerprint data from step 21 belongs to a person who is pre-registered, and therefore, authorized to use the electronics apparatus.

FIG. 10 illustrates a flow diagram for a process according to another preferred embodiment. This process includes authentication without using minutiae, i.e., selected reference points, of the identifying feature and is thus sometimes called a “non-template method”. According to this process, a known user's identifying feature is captured as an image by a digital camera built into an electronic apparatus. The image data are stored in element 41. When a user attempts to access the electronics apparatus, the user's fingerprint image is acquired by the same built in digital camera as was used to obtain the fingerprint images of the pre-registered, known users. The user's identity is authenticated by comparing the newly captured fingerprint image to the images in the pre-registered fingerprint image database in element 41. Any of the algorithms well known to those of skill in this art can be used for the comparison to authenticate the identity of the new user. For example, a “pattern matching” algorithm which does not rely upon use of minutiae can be used.

A template method or a non-template method can be used in the alternative. If a non-template method is used, it is thus seen that steps 33-36 of FIG. 9 can be avoided. FIG. 10 illustrates an embodiment in which the apparatus is equipped with the ability to implement either a template method or a non-template method. If the non-template method is used, step 39 checks to determine whether to compare the captured fingerprint image with the database 38 of minutiae data or the database 41 of pre-registered image data captured by the same digitial camera. As shown in FIG. 10, when the non-template method is used, step 39 sets a flag in step 40 to inform step 37 to use database 41. Because databases 34 and 38 are not active during this mode of operation, they are shown in phantom lines in FIG. 10.

This invention thus accomplishes fingerprint authentication with a small and lightweight fingerprint-reading system for an electronics apparatus, including a mobile terminal and a potable phone, by utilizing the existing feature of the electric apparatus in order to minimize the additional cost.

While the invention has been described in connection with preferred embodiments, it will be understood by those skilled in the art that other variations and modifications of the preferred embodiments described above may be made without departing from the scope of the invention. Other embodiments will be apparent to those skilled in the art from a consideration of the specification of practice of the invention disclosed herein. It is intended that the specification is considered as exemplary only, with the true scope and spirit of the invention of this invention being indicated by the following claims.

What is claimed is:

1. An electronic apparatus comprising
a digital camera
a fingerprint reading unit having a stamping area; and
an optical system positioned in the fingerprint reading unit and comprising a lens additional to any lens incorporated in the digital camera,
in which the fingerprint reading unit is operative to direct an image of an object on the stamping area through the lens system for capture by the digital camera.

2. The electronic apparatus of claim 1 in which the lens of the optical system has a configuration adapted to implement hyperopia correction to the image.

3. The electronic apparatus of claim 1 in which the stamping area comprises a semi-transparent film.

4. The electronics apparatus of claim 1 in which the fingerprint reading unit further comprises a source of light and a prism adapted to direct the light from the source onto the stamping area.

5. The electronics apparatus of claim 4 in which the fingerprint reading unit further comprises a light shield operative to block a peripheral portion of the light from the source from reaching the digital camera.

6. The electronics apparatus of claim 4 in which the source of light comprises a window adapted to admit external ambient light into the fingerprint reading unit.

7. The electronics apparatus of claim 4 in which the source of light is positioned within the fingerprint reading unit.

8. The electronics apparatus of claim 7 in which the source of light is activated when an object makes contact with the stamping area.

9. The electronics apparatus of claim 8 in which the source of light comprises a light-emitting polymer film which emits light in response to pressure from contact by an object against the polymer film.

10. The electronics apparatus of claim 1 in which the optical system further comprises a pinhole diaphragm positioned between the lens of the optical system and a lens of the digital camera.

11. The electronic apparatus of claim 1 in which the apparatus comprises a portable digital computer.

12. The electronic apparatus of claim 1 in which the apparatus comprises a wireless telephone.

13. A fingerprint reading and authentication method comprising the steps of
providing an electronic apparatus comprising a digital camera, and a fingerprint reading unit having a stamping area,
capturing into the digital camera a fingerprint image of a finger in contact with the stamping area,
extracting information from the fingerprint image which uniquely characterizes the fingerprint image,
comparing the information extracted which the fingerprint image to pre-registered fingerprint image data,
authenticating whether the fingerprint image is the same as any image contained in the pre-registered fingerprint image data.

14. The fingerprint reading and authentication method of claim 13 in which the electronic apparatus further comprises a security system adapted to render the electronics apparatus inoperable when activated, and in which the method further comprises the step of activating the security system to bar access of a user of the electronics apparatus unless the authenticating step verifies that the fingerprint image is the same as an image contained in the pre-registered fingerprint image data.

15. The fingerprint reading and authentication method of claim 13 which further comprises the steps of
correcting the fingerprint image obtained from the digital camera to remove distortion caused by optics of the digital camera, thereby forming a cleaned fingerprint image, and
using the cleaned fingerprint image for extracting, comparing and authenticating with the pre-registered fingerprint image data.

16. The fingerprint reading and authentication method of claim 15 in which correcting the fingerprint image obtained from digital camera comprises (a) determining a Fourier transform function which characterizes the distortion between a precise image of a subject and an image of the subject produced by the digital camera, (b) applying an inverse Fourier transform process to the fingerprint image obtained from the digital camera using the Fourier transform function determined in step (a) to form the cleaned fingerprint image.

17. The fingerprint reading and authentication method of claim 15 in which the pre-registered fingerprint image data is obtained by an apparatus comprising
a digital camera,
a fingerprint reading unit having a stamping area; and an optical system positioned in the fingerprint reading unit, in which the fingerprint reading unit is operative to direct an image of an object on the stamping area through the optical system for capture by the digital camera, and in which the optical system comprises a lens adapted to implement hyperopia correction to the fingerprint image, the lens being additional to any lens incorporated in the digital camera.
